(19) United States
(12) Patent Application Publication
(10) Pub. No.: US 2018/0056738 A1
(43) Pub. Date: Mar. 1, 2018

(54) Underlift Fork-Air Suspension Coupling Unit

(71) Applicant: Joseph Towner, Portland, MI (US)

(72) Inventor: Joseph Towner, Portland, MI (US)

(21) Appl. No.: 15/804,534

(22) Filed: Nov. 6, 2017

Related U.S. Application Data
(63) Continuation-in-part of application No. 14/616,790, filed on Feb. 9, 2015, now abandoned.
(60) Provisional application No. 62/008,546, filed on Jun. 6, 2014.

(51) Int. Cl. B60D 1/18; B60D 1/46; B60D 1/64; B60P 3/12; B60D 1/48

(52) U.S. Cl. CPC B60D 1/187; B60D 1/465; B62D 53/0857; B60P 3/125; B60D 1/486; B60D 1/64

(57) ABSTRACT

An underlift fork-air suspension coupling unit for towing a semi-trailer truck having an air-ride suspension is provided. The coupling unit includes a substantially cylindrical device including a first end configured to engage with the air suspension slot beneath the air springs of certain air-ride suspensions of semi-trailer trucks, a second end configured to engage with a receiver of an underlift towing device, and a collar coaxially disposed between the first and second ends for separating the first and second ends. The coupling unit replaces underlift forks that are conventionally used with underlift towing devices. By specifically engaging with the air suspensions slot of these air-ride suspensions, rather than the axle as with the underlift forks, the coupling unit avoids the potential for the underlift device to bottom out against the underbody of the semi-trailer truck to be towed.

### CROSS REFERENCE TO RELATED APPLICATION

This application claims priority from and is a continuation-in-part application of co-pending U.S. patent application Ser. No. 14/616,790 filed on Feb. 9, 2015, which claims the benefit of U.S. Provisional Application No. 62/008,546 filed on Jun. 6, 2014. The above identified patent applications are herein incorporated by reference in their entirety to provide continuity of disclosure.

### BACKGROUND OF INVENTION

The present invention relates to devices for assisting in towing vehicles. More specifically, the present invention relates to an underlift fork-air suspension coupling unit for assisting in towing semi-trailer trucks having a specific air-ride suspension so as to avoid causing damage to any components disposed on the underbody of the truck.

There are two main types of underlift towing systems: wheel lift systems and axle fork systems. Conventional axle fork towing systems utilize a hydraulic lifting device having a pair of arms with receiver slots disposed at the ends of the arms. An axle fork is placed within each of the receivers, wherein the configuration of the axle fork corresponds to the design of the axle of the truck to be towed. The hydraulic lifting device is then positioned so that the axle forks engage with the truck's axle on either side of the differential. The hydraulic lifting device can then be raised, lifting the truck by the axle.

Although generally effective, towing a semi-trailer truck using a conventional axle fork system has numerous disadvantages. First, it can be challenging to properly position the hydraulic lifting device so that the axle forks properly engage with the truck's axle. Second, if the axle forks are not placed properly, then the T-bar of the hydraulic lifting device can bottom out against the underbody of the truck. This can cause damage to a number of different components disposed on the underbody of the truck, including the temperature sensor disposed on many rear differentials. Replacing the temperature sensor can be very costly and time-consuming. Some models of trucks, including Peterbilt and Kenworth semi-trailer trucks, have a specific air suspension slot disposed on their air-ride suspensions with which a coupling device could engage, obviating the need to utilize difficult-to-position axle forks. Therefore, there is a need in the prior art for an improved means for towing a semi-trailer truck utilizing a hydraulic underlift towing device that avoids the disadvantages of the prior art towing systems.

### SUMMARY OF THE INVENTION

The following summary is intended solely for the benefit of the reader and is not intended to be limiting in any way. In view of the foregoing disadvantages inherent in the known types of underlift forks, wheel lifts, and accessories associated therewith now present in the prior art, the present invention provides an underlift fork-air suspension coupling unit wherein the same can be utilized for providing convenience for the user when towing certain models of semi-trailer truck including air-ride suspensions having a slot beneath the air springs thereof with which a coupling unit can engage, replacing conventional axle forks.

In one example of the present invention, the coupling unit comprises a body including a first end having a first diameter sized to fit within an air suspension slot disposed beneath the air springs of the air-ride suspension of a semi-trailer truck and a second end having a second diameter sized to fit within a receiver of an underlift towing device. A collar interconnects the first end and the second end and extends annularly about the body, such that the collar is coaxial with the body. The collar protrudes radially outwardly relative to the body and protrudes perpendicularly relative to a longitudinal axis of the body. The collar includes a linear length less than a linear length of the body, and includes a diameter greater than the first diameter and the second diameter, thereby preventing the collar from entering the receiver of the underlift towing device and the air suspension slot beneath of the air-ride suspension of the semi-trailer truck when the coupling unit is employed.

Although the present disclosure discusses the present invention as used with Peterbilt and Kenworth semi-trailer trucks, these models of trucks are chosen solely due to the configuration of their air-ride suspensions. Their air-ride suspensions have an air suspension slot or aperture disposed beneath the air springs with which the present coupling unit can engage and then from which the underlift towing device can lift the truck without causing damage to the air-ride suspension or any of the other components of the truck. However, any other model of vehicle or truck having such an air-ride suspension is suitable for use with the present device and method of use.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the underlift fork-air suspension coupling unit.

FIG. 2 shows a top plan view of the underlift fork-air suspension coupling unit.

FIG. 3A shows a perspective view of the underlift fork-air suspension coupling unit being inserted into the receivers of an underlift fork unit.

FIG. 3B shows a perspective view of the underlift fork-air suspension coupling unit being positioned and raised so that the coupling unit engages the air suspension slot of the air-ride suspension of a semi-trailer truck.

FIG. 3C shows a perspective view of the underlift fork-air suspension coupling unit placed within the air suspension slot of the air-ride suspension of a semi-trailer truck.

FIG. 3D shows a side view of the underlift fork-air suspension coupling unit placed within the air suspension slot of the air-ride suspension of a semi-trailer truck.

### DETAILED DESCRIPTION OF THE INVENTION

Reference is made herein to the attached drawings. Like reference numerals are used throughout the drawings to depict like or similar elements of the underlift fork-air suspension coupling unit. For the purposes of presenting a brief and clear description of the present invention, the preferred embodiment will be discussed as used for towing a semi-trailer truck, having an air-ride suspension of a certain design wherein an air suspension slot is disposed beneath the air springs of the air-ride suspension, such as a Kenworth and Peterbilt semi-trailer truck. The figures are intended for representative purposes only and should not be considered to be limiting in any respect.

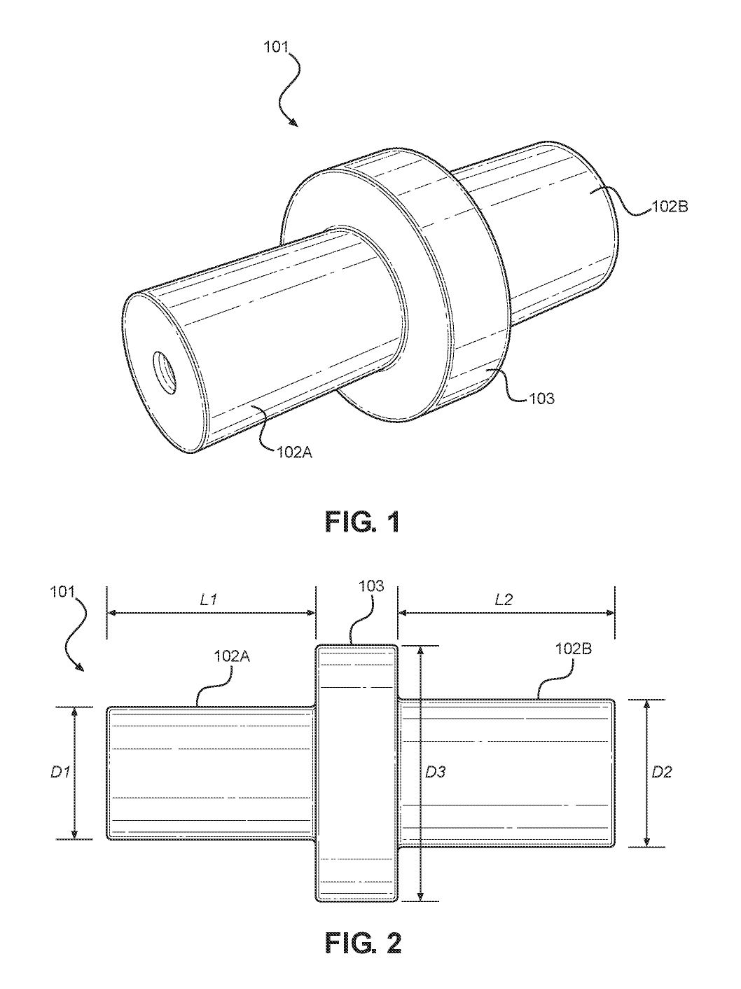

Referring now to FIGS. 1 and 2, there is shown a perspective view of the coupling unit and a top plan view of the coupling unit, respectively. The present invention comprises a coupling unit 101 configured to replace conventional axle forks, which are insertable into receivers disposed on underlift towing devices. The coupling unit 101 includes a cylindrical body having a first end 102A including a first diameter D1 and a first length L1, a second end 102B including a second diameter D2 and a second length L2, and a collar 103 coaxially disposed between the first end 102A and the second end 102B that includes as third diameter D3. The first end 102A is sized and configured to engage with an air suspension slot disposed beneath the air springs of the rear air-ride suspension of a semi-trailer truck, such as the air suspension slots of the rear air-ride suspension of a Kenworth and Peterbuilt semi-trailer truck. The second end 102B is sized and configured to engage with the receivers of an underlift towing device, and the collar 103 is sized and configured to engage the perimeter edge or frame of the rear-air ride suspension immediately surrounding the air suspension slot.

In the depicted embodiment, the first diameter D1 of the first end 102A is sized and configured to fit within an air suspension slot of the Tandem Kenworth Airglide 460 46K rear air-ride suspension of a Kenworth truck, which is present, for example, in the 2014 Kenworth Model T-800, 2014 Kenworth Model T-838, 2015 Kenworth Model T-800, 2016 Kenworth model T-800, 2017 Kenworth Model T-880, and 2018 Kenworth Model T-800. Moreover, in the depicted embodiment, the first end 102A is sized to engage an air suspension slot of the Peterbilt Air Trac rear air-ride suspension of a Peterbilt Truck, which is present, for example, in the 2014 Peterbilt Model 388, 2015 Peterbilt Model 389, 2016 Peterbilt Model 389, 2017 Peterbilt Model 389, 2018 Peterbilt Model 389, and 2018 Peterbilt Model 579.

The air suspension slots of the aforementioned Tandem Kenworth Airglide 460 46K and Peterbilt Air Trac rear air-ride suspensions each include a length of approximately 4.25 inches, a width ranging from approximately 2-3 inches, and a depth of approximately 3 inches. Therefore, the first diameter D1 includes a diameter in close tolerance to 3 inches and no greater than 3 inches, such that the first end 102A may fit into the air suspension slot ranging in width from 2-3 inches. The length L1 includes a length in close tolerance to 3 inches and no greater than 3 inches, such that the entirety of the first end 102A may fit into the air suspension slot. The third diameter D3 includes a diameter greater than 3 inches and no less than 3 inches, such that collar 103 may engage the perimeter edge or frame immediately adjacent an air suspension slot including a diameter ranging between 2-3 inches. In a preferred embodiment, the first diameter D1 is equal to 1.813 inches and the length L1 is equal to 2.875 inches, so as to facilitate insertion of the first end 102A into the air suspension slots of the Tandem Kenworth Airglide 460 46K and Peterbilt Air Trac rear air-ride suspensions that include a width ranging from 2-3 inches, and the third diameter D3 is equal to 3.5 inches for providing optimal engagement with the perimeter edge or frame of the air suspension slot and for providing optimal support to the semi-trailer truck being towed with the coupling unit 101.

The second end 102B is sized and configured to engage the receivers of the underlift towing device within a close tolerance, creating a fitment between the two components and thereby ensuring that the coupling unit 101 is securely held therein. The second diameter D2 is sized and configured to fit within receivers of the underlift towing device. As conventional receivers are cylindrical in shape and have a diameter of 2 inches, the second end 102B is cylindrical in shape in conformity with the receivers and the second diameter D2 can in turn be in close tolerance to 2 inches in order to properly engage with industry-standard receivers.

The collar 103 includes a larger diameter D3 than the diameters D1, D2 both of the first and second ends 102A, 102B, such that the collar 103 projects radially outwardly from a longitudinal length of the body and first and second ends 102A, 102B of the coupling unit 101. The length L2 of the second end 102B is larger than the length L1 of the first end 102A, so as to provide a larger weight bearing member capable of sustaining more weight thereon during the towing process. In the depicted embodiment, the length L2 of the second end 102B is 3 inches, creating an optimal length at which the second end 102B may bear weight.

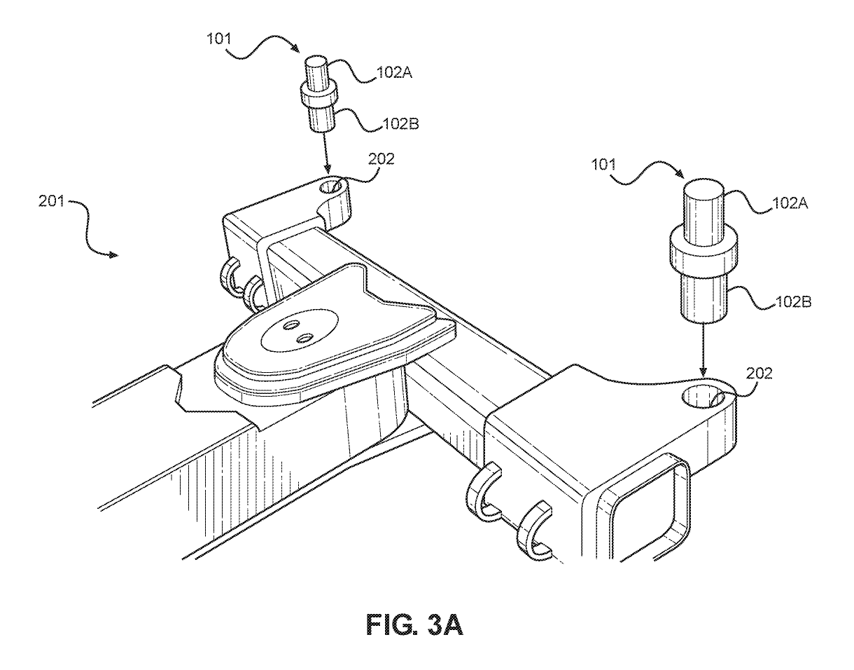

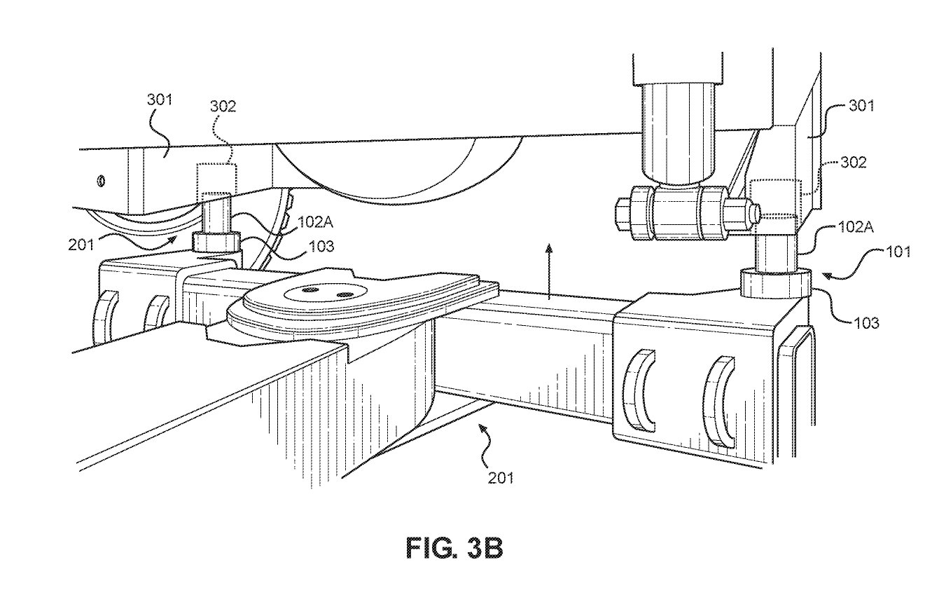

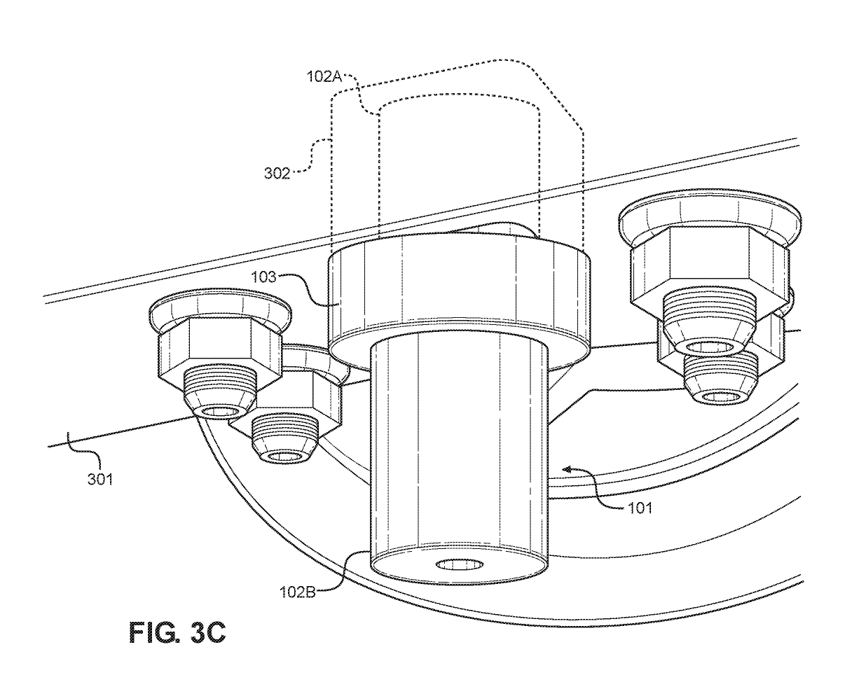

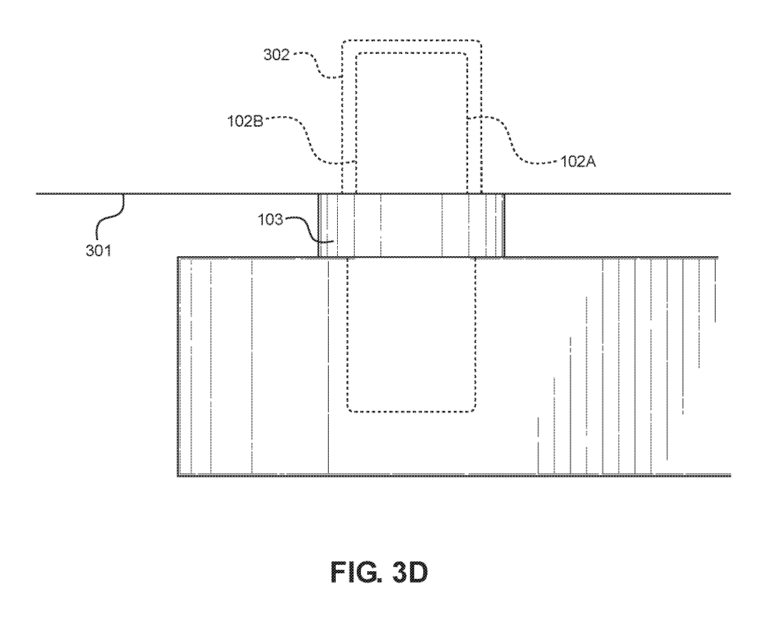

Referring now to FIGS. 3A-3D, there are shown views of the various stages of use of the coupling unit. The present method of towing a semi-trailer truck having either the Tandem Kenworth Airglide 460 46K or the Peterbilt Air Trac rear air-ride suspensions utilizes the coupling unit 101, as described above, to replace the conventional axle forks required when employing an underlift towing unit 201. To begin, the user places one or more coupling units 101 within the receivers 202 of the underlift towing unit 201. The receivers 202 are cylindrical slots disposed at the ends of the arms of the underlift towing unit 201. FIG. 2A shows the second end 102B of the coupling unit 101 being placed within the receivers 202.

Once the coupling units 101 have been secured within the receivers 202, the users then aligns the coupling units 101 with the air suspension slots 302 of the Tandem Kenworth Airglide or the Peterbilt Air Trac rear air-ride suspensions 301. Once the coupling units 101 are aligned therewith, the user can then raise the hydraulic underlift towing device 201, thereby causing the first ends 102A of the coupling units 101 to engage with the air suspension slots 302. The collar 103 preferably has a cross-sectional area greater than the cross-sectional area of the air suspension slot 302 with which the coupling unit 101 is engaging, preventing the collar 103 from entering the air suspension slot 302 and thereby ensuring that the collar 103 remains positioned between the underbody of the truck and the arms of the underlift towing unit. The collar 103 creates an offset between the underbody of the truck and the underlift towing device, preventing the arms of the underlift towing unit from making contact with the underbody of the truck and causing damage thereto. In an exemplary embodiment of the present invention, the diameter of the collar 103 is equal to three-and-one-half inches and the height of the collar 103 is equal to one and one-eighths of an inch. Once the coupling units 101 are engaged with the air suspension slots 302, the users can then continue to raise the underlift towing unit to lift the axle of the truck off of the ground so that the truck can then be towed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A coupling unit, comprising:
a body including a first end, a second end, and a collar disposed between the first end and the second end;
the first end including a first diameter and a first length, the first end sized and configured to fit within an air suspension slot of an air-ride suspension of a semi-trailer truck;
the second end including a second diameter and a second length, the second end sized and configured to fit within a receiver of an underlift towing device,
the collar including a third diameter, the collar sized and configured to engage a perimeter edge of the air suspension slot of the air-ride suspension of the semi-trailer truck;
wherein the first diameter is no greater than 3 inches;
wherein the first length is no greater than 3 inches; and
wherein the third diameter is no less than 3 inches.

2) The coupling unit of claim 1, wherein the first end of the body is sized and configured to fit within the air suspensions slots of the Tandem Kenworth Airglide 460 46K rear suspension of a Kenworth truck.

3) The coupling unit of claim 1, wherein the first end of the body is sized and configured to fit within the air suspension slots of the Peterbilt Air Trac rear suspension system of a Peterbilt Truck.

4) The coupling unit of claim 1, wherein the second diameter is greater than the first diameter, but no greater than 3 inches, and the second length is greater than the first length, but no greater than 3 inches.

5) The coupling unit of claim 1, wherein the first diameter is equal to 1.183 inches.

6) The coupling unit of claim 5, wherein the first length is equal to 2.875 inches.

7) The coupling unit of claim 6, wherein the second diameter is equal to 2 inches.

8) The coupling unit of claim 7, wherein the second length is equal to 3 inches.

9) The coupling unit of claim 4, wherein the third diameter is greater than the second diameter.

10) The coupling unit of claim 9, wherein the third diameter is equal to 3.5 inches.

11) The coupling unit of claim 1, wherein the collar is coaxial with the first end and second end of the body.

12) The coupling unit of claim 1, wherein the collar extends annularly about the body, such that the collar protrudes radially outwardly and perpendicularly relative to the body.

13) The coupling unit of claim 1, wherein the collar includes a linear length that is less than a linear length of the body.
